(19) United States
(12) Patent Application Publication
(10) Pub. No.: US 2025/0362956 A1
(43) Pub. Date: Nov. 27, 2025

(54) WORK-GROUP PROCESSING METHOD AND APPARATUS, COMPUTER DEVICE, STORAGE MEDIUM, AND COMPUTER PROGRAM PRODUCT

(71) Applicant: Glenfly Tech Co., Ltd., Shanghai (CN)

(72) Inventors: Zhulin CHANG, Shanghai (CN); Huaisheng ZHANG, Shanghai (CN)

(21) Appl. No.: 19/213,468

(22) Filed: May 20, 2025

(30) Foreign Application Priority Data
May 21, 2024 (CN) 202410636570.3

(51) Int. Cl. G06F 9/50; G06F 9/30

(52) U.S. Cl. CPC G06F 9/5011; G06F 9/30065; G06F 2209/503

(57) ABSTRACT

Work-group processing method and apparatus, computer device, storage medium, and computer program product are provided. The method includes: determining, by a driver, a number of folded work-groups; folding initial index space based on the number of the folded work-groups, to obtain target index space; transmitting work-groups described by the target index space to a device end, the work-groups described by the target index space being utilized to instruct the device end to construct waves; and acquiring fold information of the work-groups in the target index space from the driver, transmitting the fold information of the work-groups to a compiler, and unrolling folded work-groups in the target index space based on the fold information of the work-groups by the compiler, to map the folded work-groups to multiple work-groups described by the initial index space; unrolled work-groups being processed in the waves constructed by the device end.

### CROSS-REFERENCE TO RELATED APPLICATION

This application claims priority to Chinese Patent Application No. 202410636570.3, filed with CNIPA on May 21, 2024, entitled “WORK-GROUP PROCESSING METHOD AND APPARATUS, COMPUTER DEVICE, STORAGE MEDIUM, AND COMPUTER PROGRAM PRODUCT”, the entire contents of which are incorporated herein by reference.

### TECHNICAL FIELD

The present disclosure relates to the field of computer technologies, and in particular, to a work-group processing method, a work-group processing apparatus, a computer device, a storage medium, and a computer program product.

### BACKGROUND

OpenCL is a framework for writing programs for a heterogeneous platform. The heterogeneous platform may include a central processing unit (CPU), a graphics processing unit (GPU), or other types of processors. OpenCL is formed by a language (based on C99) for writing kernels (kernel functions that run on an OpenCL device) and a set of Application Programming Interfaces (APIs) for defining and controlling the platform.

In the conventional art, when a GPU hardware executes an OpenCL kernel, the kernel may be executed in units of waves. A GPU computer shader thread constructor (CSTC) is responsible for dividing a work-group into multiple waves and performing task emission.

However, the GPU CSTC may generate a lot of hardware overhead when processing the work-group into waves and performing task emission, the hardware overhead mainly consumed on constructing/releasing resources (context hardware resources such as registers). In the conventional solution, for each work-group, the CSTC is required to divide it into multiple waves that are scheduled to processing elements (PEs) for parallel execution, and recover, after the waves have been executed, resources for next work-group dividing and execution. The above solution may lead to overhead for frequent construction/release of resources (context hardware resources such as registers), decreasing the execution efficiency of waves.

### SUMMARY

In view of the above technical problems, there is a need to provide a work-group processing method, a work-group processing apparatus, a computer device, a computer-readable storage medium, and a computer program product, which can reduce a workload of hardware CSTC, thereby reducing hardware overhead caused by constructing/releasing resources at a device end.

In a first aspect, the present disclosure provides a work-group processing method, including:
determining, by a driver, a number of folded work-groups;
folding an initial index space based on the number of the folded work-groups, to obtain a target index space;
transmitting work-groups described by the target index space to a device end, the work-groups described by the target index space being utilized to instruct the device end to construct waves; and
acquiring fold information of the work-groups in the target index space from the driver, transmitting the fold information of the work-groups to a compiler, and unrolling folded work-groups in the target index space based on the fold information of the work-groups by the compiler, to map the folded work-groups in the target index space to multiple work-groups described by the initial index space; where unrolled work-groups are processed in the waves constructed by the device end.

In an embodiment, determining, by the driver, the number of the folded work-groups includes:
acquiring hardware resource information of the device end and hardware resource information required to execute tasks of the work-groups described by the initial index space; and
determining the number of the folded work-groups based on the hardware resource information of the device end and the hardware resource information required to execute the tasks of the work-groups described by the initial index space.

In an embodiment, folding the initial index space based on the number of the folded work-groups, to obtain the target index space includes:
determining target numbers of work-groups in respective dimensions according to a preset rule and the number of the folded work-groups;
acquiring initial numbers of work-groups in respective dimensions and initial numbers of work-items in respective dimensions in the initial index space;
determining fold counts in respective dimensions based on the target numbers in corresponding dimensions and the initial numbers of the work-groups in the corresponding dimensions;
acquiring first fold steps corresponding to the work-groups and second fold steps corresponding to the work-items; and
folding the initial index space based on the fold counts, the first fold steps, the initial numbers of the work-groups, the second fold steps, and the initial numbers of the work-items, to obtain the target index space.

In an embodiment, transmitting, by the driver, the fold information of the work-groups to the compiler includes:
transmitting, by the driver, initial numbers of work-groups in respective dimensions and initial numbers of work-items in respective dimensions in the initial index space, fold counts in respective dimensions, first fold steps corresponding to the work-groups, and second fold steps corresponding to the work-items to the compiler.

In an embodiment, unrolling, by the compiler, the folded work-groups in the target index space based on the fold information of the work-groups includes:
unrolling the folded work-groups and folded work-items in the target index space in respective dimensions based on the fold counts in respective dimensions, the first fold steps corresponding to the work-groups and the second fold steps corresponding to the work-items;
stopping the unrolling when numbers of unrolled work-groups in respective dimensions are equal to the initial numbers of the work-groups in respective dimensions; and
updating semantic information of respective work-item functions based on the initial numbers of the work-groups in respective dimensions and the initial numbers of the work-items in respective dimensions in the initial index space, the first fold steps, and the second fold steps.

In an embodiment, unrolling the folded work-groups and folded work-items in the target index space in respective dimensions based on the fold counts in respective dimensions, the first fold steps corresponding to the work-groups and the second fold steps corresponding to the work-items includes:
performing unrolling in respective dimensions by taking the fold counts in respective dimensions as respective unrolling loop count thresholds and taking respective current loop counts as respective loop variables in respective dimensions;
in a case that the loop variable in a current dimension is less than the corresponding unrolling loop count threshold, determining positions of unrolled work-groups in the current dimension based on the first fold steps corresponding to the work-groups, determining a number of the unrolled work-groups based on the fold count in the current dimension, and unrolling the work-groups in the current dimension based on the positions of the unrolled work-groups and the number of the unrolled work-groups; and
incrementally updating a current loop variable until the current loop variable in the current dimension is no less than the corresponding unrolling loop count threshold, acquiring a next dimension as the current dimension, and proceeding to the step of determining positions of unrolled work-groups in the current dimension based on the first fold steps corresponding to the work-groups until the folded work-groups in the target index space are unrolled in each dimension.

In an embodiment, updating the semantic information of respective work-item functions based on the initial numbers of the work-groups in respective dimensions and the initial numbers of the work-items in respective dimensions in the initial index space, the first fold steps, and the second fold steps includes:
obtaining serial numbers of the work-groups in respective dimensions after unrolling based on serial numbers of the work-groups in respective dimensions before unrolling, the unrolling loop count thresholds in corresponding dimensions, the current loop counts in the corresponding dimensions, and the first fold steps in the corresponding dimensions;
obtaining serial numbers of global work-items in the corresponding dimensions after unrolling based on the serial numbers of the work-groups in respective dimensions after unrolling, the second fold steps in the corresponding dimensions, serial numbers of work-items within the work-groups in the corresponding dimensions before unrolling, and a global offset;
updating numbers of the work-groups in respective dimensions after unrolling based on the initial numbers of the work-groups in respective dimensions in the initial index space; and
updating numbers of the work-items in respective dimensions after unrolling based on the initial numbers of the work-items in respective dimensions in the initial index space.

In an embodiment, updating the semantic information of respective work-item functions based on the initial numbers of the work-groups in respective dimensions and the initial numbers of the work-items in respective dimensions in the initial index space, the first fold steps, and the second fold steps includes:
obtaining serial numbers of the work-groups in respective dimensions after unrolling based on serial numbers of the work-groups in respective dimensions before unrolling, the current loop counts in corresponding dimensions, and the first fold steps in the corresponding dimensions;
obtaining serial numbers of global work-items in the corresponding dimensions after unrolling based on serial numbers of the global work-items in respective dimensions before unrolling, the second fold steps in the corresponding dimensions, the current loop counts in the corresponding dimensions, and a global offset;
updating numbers of the work-groups in respective dimensions after unrolling based on the initial numbers of the work-groups in respective dimensions in the initial index space; and
updating numbers of the work-items in respective dimensions after unrolling based on the initial numbers of the work-items in respective dimensions in the initial index space.

In a second aspect, the present disclosure further provides a work-group processing apparatus, including:
a fold data determination module, configured to determine, by a driver, a number of folded work-groups;
a fold module, configured to fold an initial index space based on the number of the folded work-groups, to obtain a target index space;
a transmission module, configured to transmit work-groups described by the target index space to a device end, the work-groups described by the target index space being utilized to instruct the device end to construct waves; and
a compilation module, configured to acquire fold information of the work-groups in the target index space from the driver, transmit the fold information of the work-groups to a compiler, and unroll folded work-groups in the target index space based on the fold information of the work-groups by the compiler, to map the folded work-groups in the target index space to multiple work-groups described by the initial index space; where unrolled work-groups are processed in the waves constructed by the device end.

In a third aspect, the present disclosure further provides a computer device, including a memory and a processor, the memory storing a computer program, where the processor, when executing the computer program, performs steps of the method in any one of the foregoing embodiments.

In a fourth aspect, the present disclosure further provides a non-transitory computer-readable storage medium, having a computer program stored thereon, where the computer program, when executed by a processor, causes the processor to perform steps of the method in any one of the foregoing embodiments.

In a fifth aspect, the present disclosure further provides a computer program product, including a computer program, where the computer program, when executed by a processor, causes the processor to perform steps of the method in any one of the foregoing embodiments.

According to the work-group processing method, the work-group processing apparatus, the computer device, the storage medium, and the computer program product, the number of folded work-groups is determined by the driver; the initial index space is folded based on the number of the folded work-groups, to obtain the target index space; and work-groups described by the target index space are transmitted to the device end, where the work-groups described by the target index space are utilized to instruct the device end to construct waves. In this way, the number of the folded work-groups actually seen by the device end are required to be executed, so that one context organization at the device end can actually be responsible for multiple original work-groups before fold, so as to reduce context construction overhead of the CSTC. Moreover, the work-groups are unrolled by the compiler, so that there may be no errors when the device end performs task processing, which ensures correct execution of the tasks and reduces the workload of the hardware CSTC, thereby reducing hardware overhead caused by constructing/releasing resources by the CSTC.

### BRIEF DESCRIPTION OF THE DRAWINGS

In order to more clearly illustrate the technical solutions in embodiments of the present disclosure or the related art, the accompanying drawings used in the description of the embodiments or related technology are briefly introduced below. It is apparent that, the accompanying drawings in the following description are only for some embodiments of the present disclosure, and other drawings can be obtained by those of ordinary skill in the art from the provided drawings without creative efforts.

FIG. 1 is a schematic diagram of an OpenCL framework according to an embodiment;

FIG. 2 is a schematic diagram of an OpenCL execution model according to an embodiment;

FIG. 3 is a schematic diagram of wave construction in related technology;

FIG. 4 is a schematic flowchart of a work-group processing method according to an embodiment;

FIG. 5 is a flowchart of work-group folding and unrolling processes according to an embodiment;

FIG. 6 is a schematic diagram of folding of work-groups according to an embodiment;

FIG. 7 is a schematic diagram of a continuous unrolling scheme of work-groups according to an embodiment;

FIG. 8 is a schematic diagram of a skipping unrolling scheme of work-groups according to an embodiment;

FIG. 9 is a structural block diagram of a work-group processing apparatus according to an embodiment; and

FIG. 10 is a diagram of an internal structure of a computer device according to an embodiment.

### DETAILED DESCRIPTION

In order to make the objectives, technical solutions, and advantages of the present disclosure clearer, the present disclosure is further described in detail below according to embodiments in conjunction with the accompanying drawings. It should be understood that specific embodiments described herein are intended only to explain the present disclosure rather than to limit the present disclosure.

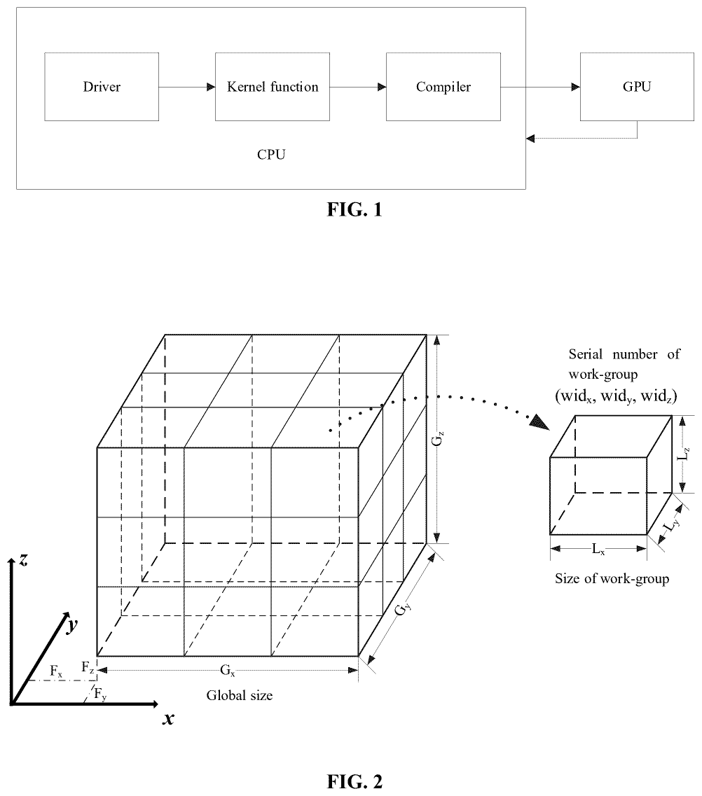

To facilitate the understanding of the present disclosure, OpenCL is introduced. Reference can be made to FIG. 1, which is a schematic diagram of an OpenCL framework according to an embodiment. In the embodiment, for simplicity, a CPU is taken as the representative of a host end, and a GPU is taken as a main body of an OpenCL device. An OpenCL execution model includes work-groups, work-items, an N-Dimensional Range (NDRange, which is an index space), work-item functions, and the like. A GPU CSTC is responsible for accepting an OpenCL work-group (work-items), dividing the OpenCL work-group into waves (a certain number of work-items are packaged into a wave), and then performing task emission.

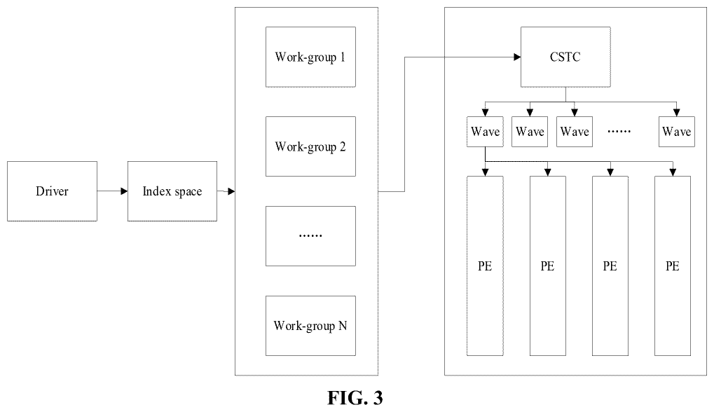

Reference can be further made to FIG. 2, which is a schematic diagram of an OpenCL execution model according to an embodiment. Computer shaders (CSs) on OpenCL and other platforms use similar execution models, generally using a three-dimensional representation to partition parallel computing spaces. Three sets of arrays are required, and each set uses three integer arrays of 32 bits to represent the computing space. The three-dimensionally represented computing space is also called an NDRange (index space), including the following three parts: a three-dimensional size of the work-group, also known as a local size and represented by a triple: (Lₓ, L_{y}, L_{z}); a three-dimensional size of a global space, also known as a global size and represented by a triple: (Gₓ, G_{y}, G_{z}); and an offset of the global space, also known as a global offset and represented by a triple: (Fₓ, F_{y}, F_{z}).

Reference is made to FIG. 3, which is a schematic diagram of wave construction in related technology. In related technology, when the GPU hardware executes the OpenCL kernel, the kernel may be executed in units of waves. The GPU CSTC is responsible for dividing a work-group into multiple waves and performing task emission. The OpenCL NDRange (index space) is logically organized into N work-groups, and an OpenCL driver delivers a kernel task described by the OpenCL NDRange to the GPU. A core unit of the GPU hardware includes multiple slices. Each slice has one CSTC and multiple PEs. An upstream hardware unit of the CSTC is responsible for receiving the N work-groups of the NDRange, scheduling the work-groups, and delivering a work-group execution task to the CSTC. The CSTC is responsible for dividing the work-groups into multiple waves and scheduling the waves to the PEs for parallel execution.

However, in the related technology, for each work-group, the CSTC is required to split it into multiple waves that are scheduled to the PEs for parallel execution and recover, after the waves have been executed, resources for next work-group dividing and execution, which may lead to overhead for frequent construction/release of resources (context hardware resources such as registers) and decrease in the execution efficiency of waves. In view of the above, in the present disclosure, the work-groups are folded on a driver end and unrolled on a compiler end, achieved through combination of related hardware and software at the CPU, to reduce the workload of the GPU hardware CSTC, thereby reducing the hardware overhead caused by constructing/releasing resources by the CSTC.

Referring to FIG. 2, in the present disclosure, in the OpenCL, the work-groups are executed independently of each other without depending on each other. The key in the present disclosure is to allow one work-group to actually be responsible for the work of multiple work-groups. That is, a shape of the work-group remains unchanged, and original N work-groups are folded into K work-groups by adjusting numbers of work-groups in respective dimensions (K<=N, and N is not required to be exactly divided by K). Then, the CSTC is required only to construct/release resources K times, reducing the workload of the CSTC in processing the work-groups. If K is chosen properly, an effect that each CSTC processes only one work-group can even be achieved.

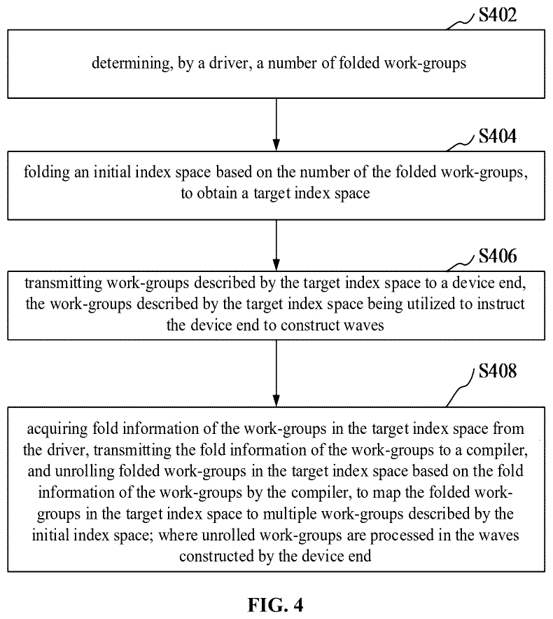

A work-group processing method is provided according to an embodiment. The embodiment is described based on an example that the method is applied to a terminal. It may be understood that the method may be alternatively applied to a server, or applied to a system including a terminal and a server and implemented by interaction between the terminal and the server. In the embodiment, the method is implemented by combination of hardware and software at the CPU. The method includes: folding work-groups at an OpenCL driver and unrolling the work-groups at an OpenCL compiler, and processing, by the GPU CSTC according to a normal logic, the work-group(s) visible to the GPU CSTC. As shown in FIG. 4, the work-group processing method includes following steps S402 to S408.

In S402, a number of folded work-groups is determined by a driver.

In the present disclosure, the number of the folded work-groups is determined by the driver. The driver may determine the number of the folded work-groups based on a case of full load of hardware resources. In other embodiments, the driver may alternatively determine the number of the folded work-groups based on other policies.

In an optional embodiment, determining, by the driver, the number of the folded work-groups includes: acquiring hardware resource information of a device end and hardware resource information required to execute tasks of work-groups described by an initial index space; and determining the number of the folded work-groups based on the hardware resource information of the device end and the hardware resource information required to execute the tasks of the work-groups described by the initial index space.

For convenience of description, it is assumed that the initial index space NDRange has a total of N work-groups. The global size is represented by Gₓ, G_{y}, and G_{z}, the local size is represented by Lₓ, L_{y}, and L_{z}, and numbers of work-groups in three dimensions xyz are respectively denoted as Nₓ, N_{y}, and N_{z}. Then, Nₓ=Gₓ/Lₓ, N_{y}=G_{y}/L_{y}, and N_{z}=G_{z}/L_{z}. Among embodiments of the present disclosure, some are illustrated in example of three dimensions, and some are illustrated in example of two dimensions. However, this does not limit that the work-group processing method in the present disclosure is applicable only to three dimensions or two dimensions. Indeed, the work-group processing method is also applicable to other dimensions, such as one dimension and four dimensions, which is not specifically limited herein.

The driver may first acquire the hardware resource information of the device end, for example, computing power information of the GPU. The driver further acquires the hardware resource information required to execute the tasks of the work-groups described by the initial index space, for example, hardware resources required by an OpenCL kernel currently running. In this way, a number of work-groups that can be accommodated in a case that a compute unit of the GPU is fully loaded is calculated, denoted as K, and numbers of work-groups in respective dimensions are determined, which are denoted respectively as Kₓ, K_{y}, K_{z}, where K=Kₓ* K_{y}* K_{z}. The number N corresponding to the number K is not required to be exactly divided by K. The compiler performs a boundary determination when unrolling the work-groups, to avoid unnecessary work-group execution.

The numbers of the work-groups in respective dimensions may be determined based on a preset rule. That is, the numbers of the folded working groups in respective dimensions are determined after a total number of the folded working groups and numbers of work-groups in respective dimensions in the initial index space are known. For example, the rule may be that the numbers of the work-groups in respective dimensions in the initial index space are divisible by the numbers of the folded working groups in respective dimensions as much as possible. Other rules may be set in other embodiments, which are not specifically limited herein.

It should be emphasized that an influence of a space capacity of a register on parallel execution of waves is mainly considered in the calculation of K. It is assumed that a current GPU has a total of P processing elements (PEs), and each PE has a register space of R bytes for parallel execution of the waves. An OpenCL kernel currently executed may be divided into multiple waves, and the waves require a register space of w Bytes in total. Then, K=P*floor(R/w), where floor(R/w) denotes a number of work-groups that can be accommodated in one PE at the same time.

In S404, the initial index space is folded based on the number of the folded work-groups, to obtain a target index space.

In S406, work-groups described by the target index space are transmitted to the device end, where the work-groups described by the target index space are utilized to instruct the device end to construct waves.

After determining the number of the folded work-groups, the driver folds the initial index space, that is, adjusts the numbers of the work-groups in respective dimensions in the initial index space, to obtain the target index space.

A process of adjusting, by the driver, the initial index space NDRange is described as follows. The size of the work-groups is maintained unchanged, and the driver actually processes K work-groups, where K=Kₓ*K_{y}*K_{z}. The device end, that is, the GPU, actually sees that K work-groups are required to be executed. In this way, the GPU CSTC is required only to process the K work-groups. After adjustment, the target index space NDRange has a global size represented by (G′ₓ, G′_{y}, G′_{z}), where G′ₓ=Kₓ*Lₓ, G′_{y}=K_{y}*L_{y}, G′_{z}=K_{z}*L_{z}, and a local size represented by (Lₓ, L_{y}, L_{z}).

In an optional embodiment, folding the initial index space based on the number of the folded work-groups, to obtain the target index space includes: determining target numbers of work-groups in respective dimensions according to the preset rule and the number of the folded work-groups; acquiring initial numbers of work-groups in respective dimensions in the initial index space and initial numbers of work-items in respective dimensions in the initial index space; determining fold counts in respective dimensions based on the target numbers in corresponding dimensions and the initial numbers of the work-groups in the corresponding dimensions; acquiring first fold steps corresponding to the work-groups and second fold steps corresponding to the work-items; and folding the initial index space based on the fold counts, the first fold steps, the initial numbers of the work-groups, the second fold steps, and the initial numbers of the work-items, to obtain the target index space.

The process of determining the target numbers of the work-groups in respective dimensions according to the preset rule and the number of the folded work-groups can be understood with reference to foregoing description.

The initial index space includes the initial numbers of the work-groups in respective dimensions and the initial numbers of the work-items in respective dimensions. The initial numbers of the work-groups in respective dimensions are Nₓ, N_{y}, and N_{z} mentioned above. The initial numbers of the work-items in respective dimensions may be obtained based on the initial numbers of the work-groups and numbers of work-items in respective dimensions within each work-group.

In this way, the work-groups can be folded based on the fold counts, the first fold steps, and the initial numbers of the work-groups, and the work-items can be folded based on the fold counts, the second fold steps, and the initial numbers of the work-items, thereby completing the fold of the initial index space and obtaining the target index space. The local size of the target index space after fold is equal to the local size of the initial index space before fold. That is, the size of the work-groups remains unchanged. The global size of the target index space after fold is equal to the global size of the initial index space before fold divided by the fold counts, and is also equal to the number of the folded work-groups multiplied by the size of the work-group.

In S408, fold information of the work-groups in the target index space is acquired by the driver, the fold information of the work-groups is transmitted to the compiler, and folded work-groups in the target index space are unrolled by the compiler based on the fold information of the work-groups, to map the folded work-groups in the target index space to multiple work-groups described by the initial index space, where unrolled work-groups are processed in the waves constructed by the device end.

The driver provides the fold information for the compiler, and informs the compiler how many rounds of unrolling each work-group requires and unrolling steps of the work-groups and the work-items. Hence, the compiler uses the fold information when performing compilation, unrolling the work-groups, updating work-item function semantics, and performing a work-group boundary determination.

Optionally, the fold information includes the initial numbers of work-groups in respective dimensions in the initial index space (that is, the initial index space includes N work-groups) and the initial numbers of work-items in respective dimensions in the initial index space (that is, the initial index space includes G work-items), fold counts in respective dimensions (i.e., the compiler is required to unroll the work-groups U times in respective dimensions, where Uₓ=ceil(Nₓ/Kₓ), U_{y}=ceil(N_{y}/K_{y}), U_{z}=ceil(N_{z}/K_{z}), and ceil means returning a smallest integer greater than or equal to a specified expression), the first fold steps corresponding to the work-groups, and the second fold steps corresponding to the work-items.

The first fold steps corresponding to the work-groups and the second fold steps corresponding to the work-items are both related to a fold scheme (an unrolling scheme), which may take different values based on the fold scheme, as shown in Table 1.

TABLE 1

| | A total of N | A total of G | | | | | |
|---|---|---|---|---|---|---|---|
| | work-groups in | work-items in | Unroll the | Work-group continuous | | Work-group skipping | |
| | an initial index | the initial index | work-groups U | unrolling scheme | | unrolling scheme | |
| | space in | space in | times in | First | Second | First | Second |
| | respective | respective | respective | fold | fold | fold | fold |
| | dimensions | dimensions | dimensions | steps | steps | steps | steps |
| x-dimension | Nₓ | Gₓ | Uₓ = ceil(Nₓ/Kₓ) | 1 | Lₓ | Kₓ | G′ₓ |
| y-dimension | N_{y} | G_{y} | U_{y} = ceil(N_{y}/K_{y}) | 1 | L_{y} | K_{y} | G′_{y} |
| z-dimension | N_{z} | G_{z} | U_{z} = ceil(N_{z}/K_{z}) | 1 | L_{z} | K_{z} | G′_{z} |

The compiler may unroll the folded work-groups in the target index space based on the fold information, and accordingly, the device end can perform task processing based on the work-groups described by the initial index space after compilation. In this way, the CSTC is required to construct/release resources only K times to achieve task processing for N work-groups. Hence, context for work-group task emission by the CSTC can be reused. That is, one time of context organization by the CSTC may be responsible for tasks of multiple work-groups, thereby reducing context construction overhead of the CSTC.

For the convenience of understanding, work-groups after unrolling are called as first work-groups, which are correspondingly mapped to multiple work-groups described by the initial index space. Work-groups before unrolling are called as second work-groups, which correspond to work-groups described by the target index space. The second work-groups are unrolled to obtain the first work-groups. In this way, the device end constructs waves based on the second work-groups. Specifically, one second work-group is constructed into one wave set, and the first work-groups are processed in wave sets corresponding to the second work-groups that correspond to the first work-groups. That is, work-group and waves are in a one-to-many correspondence. One work-group may be divided into one or more waves.

According to the work-group processing method, the number of folded work-groups is determined by the driver; the initial index space is folded based on the number of the folded work-groups, to obtain the target index space; and work-groups described by the target index space are transmitted to the device end, where the work-groups described by the target index space are utilized to instruct the device end to construct waves. In this way, the number of the folded work-groups actually seen by the device end are required to be executed, so that one context organization at the device end can actually be responsible for multiple original work-groups before fold, so as to reduce context construction overhead of the CSTC. Moreover, the work-groups are unrolled by the compiler, so that there may be no errors when the device end performs task processing, which ensures correct execution of the tasks and reduces the workload of the hardware CSTC, thereby reducing hardware overhead caused by constructing/releasing resources by the CSTC.

In an optional embodiment, unrolling, by the compiler, folded work-groups in the target index space based on the fold information of the work-groups includes: unrolling the folded work-groups and folded work-items in the target index space in respective dimensions based on the fold counts in respective dimensions, the first fold steps corresponding to the work-groups and the second fold steps corresponding to the work-items; stopping the unrolling when numbers of unrolled work-groups in respective dimensions are equal to the initial numbers of the work-groups in respective dimensions; and updating semantic information of respective work-item functions based on the initial numbers of the work-groups in respective dimensions in the initial index space, the initial numbers of the work-items in respective dimensions in the initial index space, the first fold steps, and the second fold steps.

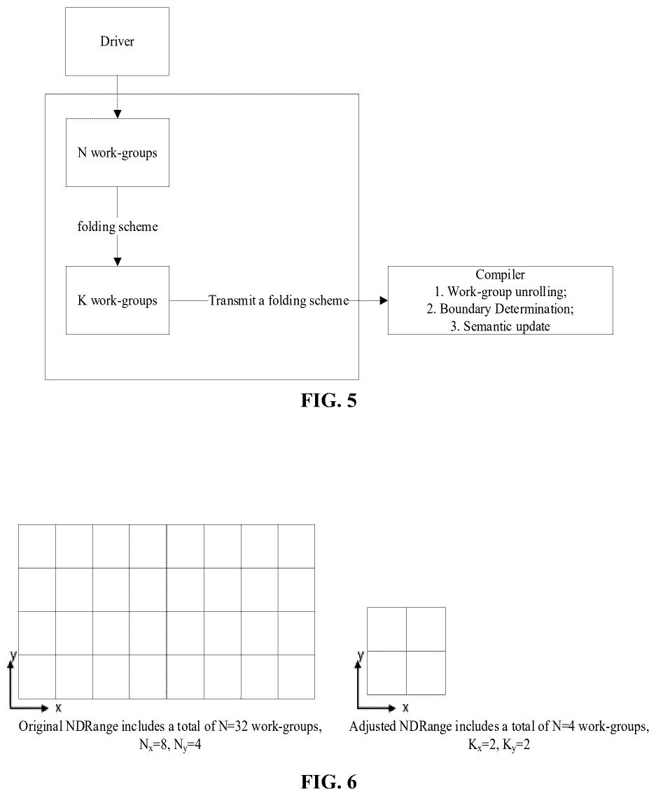

Reference may be made to FIG. 5, which is a flowchart of work-group folding and unrolling processes according to an embodiment. In the embodiment, a driver acquires a fold scheme, acquires an initial index space, folds work-groups in the initial index space to obtain a target index space, and transmits the fold scheme to a compiler, and the compiler acquires the target index space and unrolls the target index space.

When unrolling the work-groups, the compiler mainly performs three operations. The first operation is to unroll the work-groups, the second operation is to perform a boundary-break determination, and the third operation is to update semantic information of work-item functions.

In terms of the first operation of unrolling of the work-groups, the compiler unrolls the work-groups in respective dimensions sequentially. The second operation of the boundary-break determination refers to that, in a case that the fold count is not an integer, there is a need to determine whether the unrolled work-groups exceed the work-groups in each dimension; if a determination result is positive, unrolling in the dimension is terminated. The third operation of updating the semantic information of the work-item functions includes updating semantic information of multiple corresponding work-item functions, focusing on updating changed semantic information of work-item functions, such as global work-items serial numbers of work-items and work-group serial numbers. Other work-item functions whose semantic information does not change include numbers of global work-items in respective dimensions, numbers of work-items in work-groups, serial numbers of work-items within the work-groups in respective dimensions, and serial numbers of the work-groups in respective dimensions.

In an optional embodiment, unrolling the folded work-groups and folded work-items in the target index space in respective dimensions based on the fold counts in respective dimensions, the first fold steps corresponding to the work-groups and the second fold steps corresponding to the work-items includes: performing unrolling in respective dimensions by taking the fold counts in respective dimensions as respective unrolling loop count thresholds and taking respective current loop counts as respective loop variables in respective dimensions; in a case that the loop variable in a current dimension is less than the corresponding unrolling loop count threshold, determining positions of unrolled work-groups in the current dimension based on the first fold steps corresponding to the work-groups, determining a number of the unrolled work-groups based on the fold count in the current dimension, and unrolling the work-groups in the current dimension based on the positions of the unrolled work-groups and the number of the unrolled work-groups; and incrementally updating a current loop variable until the current loop variable in the current dimension is no less than the corresponding unrolling loop count threshold, acquiring a next dimension as the current dimension, and proceeding to the step of determining the positions of unrolled work-groups in the current dimension based on the first fold steps corresponding to the work-groups until the folded work-groups in the target index space are unrolled in each dimension.

For the sake of simplicity, two-dimensional vecAssign is taken as an example in the following description. Work-group folding/unrolling of one-dimensional and three-dimensional NDRanges has the same logic as two-dimensional. Assuming that the initial index space NDRange has a total of N=32 work-groups (Nₓ=8, N_{y}=4, N_{z}=1), through computing power evaluation, the driver calculates that for the current OpenCL kernel, the compute unit of the GPU can accommodate K=4 work-groups under full load, and determines numbers of work-groups in respective dimensions to be Kₓ=2, K_{y}2, and K_{z}=1. Referring to FIG. 6, the fold scheme of the work-groups of the device end is to fold 4 times in one direction and 2 times in another direction.

In this way, when the work-groups are unrolled, each work-group is required to be responsible for N/K=8 rounds of unrolling of the work-groups, denoted as U. Uₓ=ceil(Nₓ/Kₓ)=4 rounds of unrolling of the work-groups are required in the x dimension, and U_{y}=ceil(N_{y}/K_{y})=2 rounds of unrolling of the work-groups are required in the y dimension, where the compiler is responsible for the unrolling. Regarding this, there are also 2 schemes: a work-group continuous unrolling scheme and a work-group skipping unrolling scheme. In the two schemes, the compiler controls unrolling of the work-groups in respective dimensions with the same logic, that is, sequentially performs Uₓ, U_{y}, and U_{z} rounds of unrolling of the work-groups in the respective dimensions, and uses updated semantic information of the work-item functions in a loop body.

A specific unrolling process may be as follows. fold counts in respective dimensions are taken as respective unrolling loop count thresholds, and a current loop count corresponding to each dimension is acquired. An initial value of the current loop count is 0. In this way, in a case that the current loop count is less than the unrolling loop count threshold, work-groups are unrolled in a current dimension, and the current loop count is incrementally updated. Moreover, during the unrolling, it is determined whether the number of unrolled work-groups in the current dimension is equal to the number of work-groups in the current dimension in the initial index space. If a determination result is positive, the unrolling of the work-groups in the current dimension is ended, work-groups in a next dimension are acquired and unrolling is further performed in the next dimension, until the work-groups are unrolled in each dimension, and then the work-item functions are semantically updated.

The work-group continuous unrolling scheme and the work-group skipping unrolling scheme are different in semantic updating manners of the work-item functions, which involves the following functions. A parameter dim falls within a value range of 0, 1, and 2, pointing to 3 dimensions x, y, and z respectively:

TABLE 2

| | |
|---|---|
| size_t get_global_size | return a number of global work-items in |
| (uint dim); | the dimension specified by dim |
| size_t get_global_id | return a global work-item ID of a current |
| (uint dim); | work-item in the dimension specified by dim |
| size_t get_local_size | return a number of work-items in work-groups |
| (uint dim); | in the dimension specified by dim |
| size_t get_local_id | return a work-item ID within work-group of a |
| (uint dim); | current work-item in the dimension specified |
| | by dim |
| size_t get_num_groups | return a number of work-groups in the |
| (uint dim); | dimension specified by dim |
| size_t get_group_id | return IDs of the work-groups in the |
| (uint dim); | dimension specified by dim |

Here, size_t get_global_size (uint dim) and size_t get_num_groups (uint dim) may not change due to the unrolling of the work-groups, and correspond to variables G and N respectively. Moreover, during work-group folding/unrolling in the present disclosure, the shape of the work-groups is kept unchanged, so semantics of size_t get_local_size (uint dim) and size_t get_local_id (uint dim) do not change, and the compiler is not required to update the semantics thereof when unrolling the work-groups. When unrolling the work-groups, the compiler is required to pay attention to a semantic update scheme for the following 2 functions: size_t get global_id (uint dim) and size_t get_group_id (uint dim). To facilitate distinction between the work-item functions before and after the semantic update, in the embodiment, the work-item functions after the work-group unrolling and the semantic update are called: size_t get_global_id_wgunroll (uint dim) and size_t get_group_id_wgunroll (uint dim).

To facilitate the understanding, the work-group continuous unrolling scheme and the work-group skipping unrolling scheme are respectively explained.

In the work-group continuous unrolling scheme, each work-group is unrolled with a first step of 1 (work-group step=1) in each dimension, and finally, 1 work-group is unrolled into U work-groups that are continuous in each dimension. From the perspective of work-items, a second step (work-item step) at which the work-items are unrolled is a number of work-items of the work-group in each dimension: Lₓ, L_{y}, or L_{z}. Hence, the work-group step is 1 in each dimension, and the work-item step is Lₓ, L_{y}, or L_{z}.

Referring to FIG. 7, a work-group at position (0, 0) is unrolled with step=1 in the x and y dimensions respectively: unrolled Uₓ=4 rounds in the x dimension into 4 continuous work-groups, and unrolled U_{y}=2 rounds in the y dimension into 2 continuous work-groups. After the unrolling, the work-group at position (0, 0) corresponds to the following 8 work-groups in the initial NDRange: (0,0), (1,0), (2,0), (3,0), (0,1), (1,1), (2,1), and (3,1).

The compiler sequentially performs Uₓ, U_{y}, and U_{z} rounds of unrolling of the work-groups in respective dimensions, and uses a kernel function that updates semantics of the work-item functions in a loop body. To facilitate the description, variables are first explained: loop counts (Ipcnt) for work-group unrolling in respective dimensions are Uₓ, U_{y}, and U_{z}; loop variables (lpvar) for work-group unrolling in respective dimensions are x, y, and z; numbers of work-items within the work-groups (local size) in respective dimensions are Lₓ, L_{y}, and L_{z}, which are also the second fold steps in the work-group continuous unrolling scheme; and a global offset is represented by Fₓ, F_{y}, and F_{z}.

In an optional embodiment, updating the semantic information of respective work-item functions based on the initial numbers of the work-groups and the initial numbers of the work-items in respective dimensions in the initial index space, the first fold steps, and the second fold steps includes: obtaining serial numbers of the work-groups in respective dimensions after unrolling based on serial numbers of the work-groups in respective dimensions before unrolling, the unrolling loop count thresholds in the corresponding dimensions, the current loop counts in the corresponding dimensions, and the first fold steps in the corresponding dimensions; obtaining serial numbers of global work-items in the corresponding dimensions after unrolling based on the serial numbers of the work-groups in respective dimensions after unrolling, the second fold steps in the corresponding dimensions, serial numbers of work-items within the work-groups in the corresponding dimensions before unrolling, and the global offset; updating numbers of the work-groups in respective dimensions after unrolling based on the initial numbers of the work-groups in respective dimensions in the initial index space; and updating numbers of the work-items in respective dimensions after unrolling based on the initial numbers of the work-items in respective dimensions in the initial index space.

Specifically, to facilitate understanding, in the work-group continuous unrolling scheme, an update scheme for the work-item functions get_global_id (dim) and get_group_id (dim) is as follows:

get_group_id_wgunroll(dim)=get_group_id(dim)*lpcnt+lpvar*(work-group
step);
get_global_id_wgunroll(dim)=get_group_id_wgunroll(dim)*(local
size)+get_local_id(dim)+(global offset).

Specifically, herein, unrolling is performed in 3 dimensions x, y, and z with the first fold steps of 1 based on formulas, and a work-item function update solution for the work-group continuous unrolling scheme can be obtained:

get_group_id_wgunroll(0) = get_group_id(0)*Uₓ + x;
get_group_id_wgunroll(1) = get_group_id(1)*U_{y} + y;
get_group_id_wgunroll(2) = get_group_id(2)*U_{z} + z;
get_global_id_wgunroll(0)=(get_group_id(0)*Uₓ+x)*Lₓ+get_local_id(0)+ Fₓ;
get_global_id_wgunroll(1)=(get_group_id(1)*U_{y}+y)*L_{y}+get_local_id(1)+ F_{y};
get_global_id_wgunroll(2)=(get_group_id(2)*U_{z}+z)*L_{z}+get_local_id(2)+ F_{z}.

In the work-group skipping unrolling scheme, unrolling is performed in respective dimensions by taking a number of work-groups in the target index space NDRange that are actually processed by the driver as a work-group unrolling step. From the perspective of work-groups, the work-group unrolling step is a number of work-groups in each dimension in the target index space NDRange that are actually processed by the driver, that is, Kₓ, K_{y}, or K_{z} mentioned above. From the perspective of work-items, the work-item unrolling step is a number of work-items in each dimension in the target index space NDRange that are actually processed by the driver: G′ₓ, G′_{y}, or G′_{z}. The first fold step is Kₓ, K_{y}, or K_{z}. The second fold step is G′ₓ, G′_{y}, or G′_{z}.

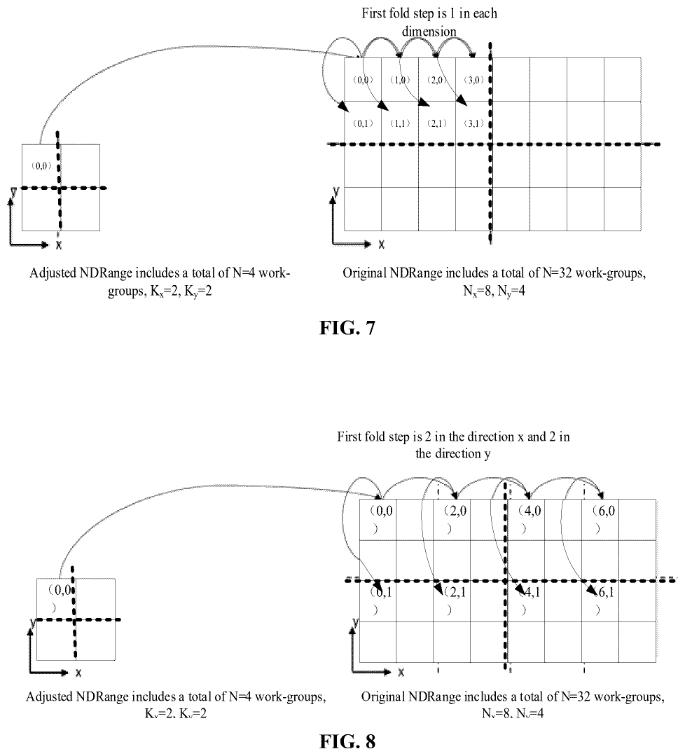

Referring to FIG. 8, a work-group at position (0, 0) is unrolled in x and y dimensions respectively: unrolled Uₓ=4 rounds in the x dimension with the first fold step of Kₓ=2, and unrolled U_{y}2 rounds in the y dimension with the first fold step of K_{y}=2. After the unrolling, the work-group at position (0, 0) corresponds to the following 8 work-groups in the initial index space NDRange: (0,0), (2,0), (4,0), (6,0), (0,2), (2,2), (4,2), and (6,2).

The compiler sequentially performs Uₓ, U_{y}, and U_{z} rounds of unrolling of the work-groups in the 3 dimensions x, y, and z, and uses a kernel function that updates semantics of the work-items in a loop body. To facilitate the description, variables are explained first: loop counts (lpent) for work-group unrolling in respective dimensions are denoted as Uₓ, U_{y}, and U_{z}; loop variables (lpvar) for work-group unrolling in respective dimensions are denoted as x, y, and z; numbers of work-groups in respective dimensions in the target index space NDRange are denoted as Kₓ, K_{y}, and K_{z}, i.e., the first fold steps; numbers of work-items in respective dimensions in the target index space NDRange are denoted as G′ₓ, G′_{y}, and G′_{z}, i.e., the second fold steps; and a global offset is represented by Fₓ, F_{y}, and F_{z}.

In an optional embodiment, updating the semantic information of respective work-item functions based on the initial numbers of the work-groups and the initial numbers of the work-items in respective dimensions in the initial index space, the first fold steps, and the second fold steps includes: obtaining serial numbers of the work-groups in respective dimensions after unrolling based on serial numbers of the work-groups in respective dimensions before unrolling, the current loop counts in the corresponding dimensions, and the first fold steps in the corresponding dimensions; obtaining serial numbers of global work-items in the corresponding dimensions after unrolling based on serial numbers of the global work-items in respective dimensions before unrolling, the second fold steps in the corresponding dimensions, the current loop counts in the corresponding dimensions, and the global offset; updating numbers of the work-groups in respective dimensions after unrolling based on the initial numbers of the work-groups in respective dimensions in the initial index space; and updating numbers of the work-items in respective dimensions after unrolling based on the initial numbers of the work-items in respective dimensions in the initial index space.

Specifically, in the work-group skipping unrolling scheme, an update scheme for concerned work-time functions get_global_id (dim) and get_group_id (dim) is as follows:

get_group_id_wgunroll(dim)=get_group_id(dim)+lpvar*(work-group step);
get_global_id_wgunroll(dim)=get_global_id(dim)+lpvar*(work-item
step)+(global offset).

Unrolling is performed in 3 dimensions x, y, and z based on formulas, and a work-item function update solution for the work-group skipping unrolling scheme can be obtained:

get_group_id_wgunroll(0) = get_group_id(0) + x * Kₓ;
get_group_id_wgunroll(1) = get_group_id(1) + y * K_{y};
get_group_id_wgunroll(2) = get_group_id(2) + z * K_{z};
get_global_id_wgunroll(0) = get_global_id(0) + x * G′ₓ+ Fₓ;
get_global_id_wgunroll(1) = get_global_id(1) + y * G′_{y}+ F_{y};
get_global_id_wgunroll(2) = get_global_id(2) + z * G′_{z}+ F_{z}.

The foregoing embodiments are particularly suitable for OpenCL Kernel execution scenarios with relatively large workloads, which can significantly reduce the hardware overhead of constructing waves by the CSTC. In an actual case of choosing to enqueue K work-groups, the principle is that each CSTC on the GPU is required only to process one work-group, which makes full use of a parallel computing capability of the GPU and greatly saves the overhead of constructing/releasing resources by the CSTC. In addition, the work-group folding/unrolling scheme in the present disclosure is completely implemented at the CPU end, which are completely transparent to the GPU hardware CSTC and may not generate additional hardware overhead of the CSTC.

It should be understood that, although the steps in the flowcharts involved in the foregoing embodiments are shown in sequence as indicated by the arrows, the steps are not necessarily performed in the order indicated by the arrows. Unless otherwise clearly specified herein, the steps are performed without any strict sequence limitation, and may be performed in other orders. In addition, at least some steps in the flowcharts involved in the foregoing embodiments may include multiple sub-steps or multiple stages, and such sub-steps or stages are not necessarily performed simultaneously, and may be performed at different moments. The sub-steps or stages are not necessarily performed in sequence, and the sub-steps or stages and at least some of other steps or sub-steps or stages of other steps may be performed in turn or alternately.

Based on the same inventive concept, a work-group processing apparatus is further provided according to an embodiment of the present disclosure, for implementing the above-mentioned work-group processing method. An implementation solution for solving the problems that is provided by the apparatus is similar to the implementation solution of the above-mentioned method. Therefore, for specific limitations in one or more embodiments directed to the work-group processing apparatus provided below, reference may be made to the limitations on the above-mentioned work-group processing method. Details are not repeated herein.

In an exemplary embodiment, as shown in FIG. 9, a work-group processing apparatus is provided, including: a fold data determination module 901, a fold module 902, a transmission module 903, and a compilation module 904.

The fold data determination module 901 is configured to determine, by a driver, a number of folded work-groups.

The fold module 902 is configured to: fold an initial index space based on the number of the folded work-groups, to obtain a target index space.

The transmission module 903 is configured to transmit work-groups described by the target index space to a device end. The number of the folded work-groups is utilized to instruct the device end to construct waves.

The compilation module 904 is configured to: transmit, by the driver, fold information of the work-groups to a compiler, and unroll, by the compiler, the folded work-groups in the target index space based on the fold information of the work-groups, to obtain the initial index space and map the folded work-groups in the target index space to multiple work-groups described by the initial index space. Unrolled work-groups are processed in the waves constructed by the device end.

In an optional embodiment, the fold data determination module 901 is specifically configured to: acquire hardware resource information of the device end and hardware resource information required to execute tasks of the work-groups described by the initial index space; and determine the number of the folded work-groups based on the hardware resource information of the device end and the hardware resource information required to execute the tasks of the work-groups described by the initial index space.

In an optional embodiment, the fold module 902 is specifically configured to: determine target numbers of work-groups in respective dimensions according to a preset rule and the number of the folded work-groups; acquire initial numbers of work-groups in respective dimensions and initial numbers of work-items in respective dimensions in the initial index space; determine fold counts in respective dimensions based on target numbers in the corresponding dimensions and the initial numbers of the work-groups in the corresponding dimensions; acquire first fold steps corresponding to the work-groups and second fold steps corresponding to the work-items; and fold the initial index space based on the fold counts, the first fold steps, the initial numbers of the work-groups, the second fold steps, and the initial numbers of the work-items, to obtain the target index space.

In an optional embodiment, the transmission module 903 is specifically configured to: transmit, by the driver, the initial numbers of the work-groups in respective dimensions and the initial numbers of the work-items in respective dimensions in the initial index space, the fold counts in respective dimensions, the first fold steps corresponding to the work-groups, and the second fold steps corresponding to the work-items to the compiler.

In an optional embodiment, the compilation module 904 is specifically configured to: unroll the folded work-groups in the target index space in respective dimensions based on the fold counts in respective dimensions and the first fold steps corresponding to the work-groups; stop the unrolling when numbers of unrolled work-groups in respective dimensions are equal to the initial numbers of the work-groups in respective dimensions; and update semantic information of respective work-item functions based on the initial numbers of the work-groups in respective dimensions and the initial numbers of the work-items in respective dimensions in the initial index space, the first fold steps, and the second fold steps.

In an optional embodiment, the compilation module 904 is specifically configured to: performing unrolling in respective dimensions by taking the fold counts in respective dimensions as respective unrolling loop count thresholds and taking respective current loop counts as respective loop variables in respective dimensions; in a case that the loop variable in a current dimension is less than the corresponding unrolling loop count threshold, determine positions of unrolled work-groups in the current dimension based on the first fold steps corresponding to the work-groups, determine a number of the unrolled work-groups based on the fold count in the current dimension, and unroll the work-groups in the current dimension based on the positions of the unrolled work-groups and the number of the unrolled work-groups; and incrementally update a current loop variable until the current loop variable in the current dimension is no less than the corresponding unrolling loop count threshold, acquire a next dimension as the current dimension, and proceed to the step of determining the positions of unrolled work-groups in the current dimension based on the first fold steps corresponding to the work-groups until the folded work-groups in the target index space are unrolled in each dimension.

In an optional embodiment, the compilation module 904 is specifically configured to: obtain serial numbers of the work-groups in respective dimensions after unrolling based on serial numbers of the work-groups in respective dimensions before unrolling, the unrolling loop count thresholds in the corresponding dimensions, the current loop counts in the corresponding dimensions, and the first fold steps in the corresponding dimensions; obtain serial numbers of global work-items in the corresponding dimensions after unrolling based on the serial numbers of the work-groups in respective dimensions after unrolling, the second fold steps in the corresponding dimensions, serial numbers of work-items within the work-groups in the corresponding dimensions before unrolling, and the global offset; update numbers of the work-groups in respective dimensions after unrolling based on the initial numbers of the work-groups in respective dimensions in the initial index space; and update numbers of the work-items in respective dimensions after unrolling based on the initial numbers of the work-items in respective dimensions in the initial index space.

In an optional embodiment, the compilation module 904 is specifically configured to: obtain serial numbers of the work-groups in respective dimensions after unrolling based on serial numbers of the work-groups in respective dimensions before unrolling, the current loop counts in the corresponding dimensions, and the first fold steps in the corresponding dimensions; obtain serial numbers of global work-items in the corresponding dimensions after unrolling based on serial numbers of the global work-items in respective dimensions before unrolling, the second fold steps in the corresponding dimensions, the current loop counts in the corresponding dimensions, and the global offset; update numbers of the work-groups in respective dimensions after unrolling based on the initial numbers of the work-groups in respective dimensions in the initial index space; and update numbers of the work-items in respective dimensions after unrolling based on the initial numbers of the work-items in respective dimensions in the initial index space.

The modules in the above-mentioned work-group processing apparatus may be implemented entirely or partially by software, hardware, or a combination thereof. The above-mentioned modules may be built in or independent of a processor of a computer device in a hardware form, or may be stored in a memory of the computer device in a software form, to facilitate the processor to invoke and perform operations corresponding to the above-mentioned modules.

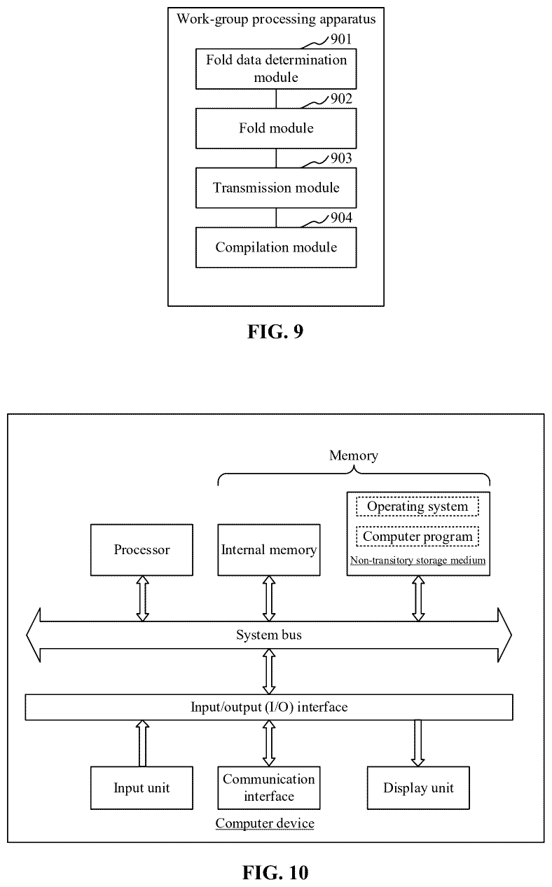

In an exemplary embodiment, a computer device is provided. The computer device may be a terminal. A diagram of an internal structure thereof may be shown in FIG. 10. The computer device includes a processor, a memory, an input/output (I/O) interface, a communication interface, a display unit, and an input unit. The processor, the memory, and the I/O interface are connected through a system bus. The communication interface, the display unit, and the input unit are connected to the system bus through the input/output (I/O) interface. The processor of the computer device is configured to provide computing and control capabilities. The memory of the computer device includes a non-transitory storage medium and an internal memory. The non-transitory storage medium stores an operating system and a computer program. The internal memory provides an environment for running of the operating system and the computer program in the non-transitory storage medium. The I/O interface of the computer device is configured to exchange information between the processor and an external device. The communication interface of the computer device is configured to communicate with an external terminal in a wired or wireless manner. The wireless manner may be implemented by WIFI, mobile cellular networks, near field communication (NFC), or other technologies. The computer program is executed by the processor to implement a work-group processing method. The display unit of the computer device is configured to form a visually visible image, and may be a display screen, a projection device, or a virtual reality imaging device. The display screen may be a liquid crystal display screen or an electronic ink display screen. The input unit of the computer device may be a touch layer covering the display screen, or may be a key, a trackball, or a touchpad disposed on a housing of the computer device, or may be an external keyboard, an external touchpad, an external mouse, or the like.

Those skilled in the art may understand that, the structure shown in FIG. 10 is only a block diagram of a partial structure related to a solution of the present disclosure, which does not constitute a limitation on the computer device to which the solution of the present disclosure is applied. Specifically, the computer device may include more or fewer components than those shown in FIG. 10, or some components may be combined, or a different component deployment may be adopted.

In an embodiment, a computer device is further provided, including a memory and a processor. The memory stores a computer program. The processor, when executing the computer program, performs steps in the foregoing embodiments directed to the method.

In an embodiment, a non-transitory computer-readable storage medium is provided, having a computer program stored thereon. The computer program, when executed by a processor, causes the processor to perform steps in the foregoing embodiments directed to the method.

In an embodiment, a computer program product is provided, including a computer program. The computer program, when executed by a processor, causes the processor to perform steps in the foregoing embodiments directed to the method.

Those of ordinary skill in the art may understand that some or all procedures in the methods in the foregoing embodiments may be implemented by a computer program instructing related hardware, the computer program may be stored in a non-transitory computer-readable storage medium, and when the computer program is executed, the procedures in the methods according to the foregoing embodiments may be implemented. Any reference to the memory, database, or other media used in the embodiments provided in the present disclosure may include at least one of a non-transitory memory or a transitory memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, and the like. The transitory memory may include a random access memory (RAM) or an external cache. By way of illustration instead of limitation, the RAM is available in a variety of forms, such as a static random access memory (SRAM) or a dynamic random access memory (DRAM). The database as referred to in the embodiments provided in the present disclosure may include at least one of a relational database or a non-relational database. The non-relational database may include a blockchain-based distributed database, and the like, but is not limited thereto. The processor as referred to in the embodiments provided in the present disclosure may be a general-purpose processor, a central processing unit, a graphics processing unit, a digital signal processor, a programmable logic device, a data processing logic device based on quantum computing, and the like, but is not limited thereto.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the protection scope of the present disclosure. It should be noted that those of ordinary skill in the art may further make variations and improvements without departing from the conception of the present disclosure, and these all fall within the protection scope of the present disclosure. Therefore, the protection scope of the present disclosure should be subject to the appended claims.

What is claimed is:

1. A work-group processing method, comprising:
determining, by a driver, a number of folded work-groups;
folding an initial index space based on the number of the folded work-groups, to obtain a target index space;
transmitting work-groups described by the target index space to a device end, the work-groups described by the target index space being utilized to instruct the device end to construct waves; and
acquiring fold information of the work-groups in the target index space from the driver, transmitting the fold information of the work-groups to a compiler, and unrolling folded work-groups in the target index space based on the fold information of the work-groups by the compiler, to map the folded work-groups in the target index space to a plurality of work-groups described by the initial index space; wherein unrolled work-groups are processed in the waves constructed by the device end.

2. The work-group processing method according to claim 1, wherein determining, by the driver, the number of the folded work-groups comprises:
acquiring hardware resource information of the device end and hardware resource information required to execute tasks of the work-groups described by the initial index space; and
determining the number of the folded work-groups based on the hardware resource information of the device end and the hardware resource information required to execute the tasks of the work-groups described by the initial index space.

3. The work-group processing method according to claim 1, wherein folding the initial index space based on the number of the folded work-groups, to obtain the target index space comprises:
determining target numbers of work-groups in respective dimensions according to a preset rule and the number of the folded work-groups;
acquiring initial numbers of work-groups in respective dimensions and initial numbers of work-items in respective dimensions in the initial index space;
determining fold counts in respective dimensions based on the target numbers in corresponding dimensions and the initial numbers of the work-groups in the corresponding dimensions;
acquiring first fold steps corresponding to the work-groups and second fold steps corresponding to the work-items; and
folding the initial index space based on the fold counts, the first fold steps, the initial numbers of the work-groups, the second fold steps, and the initial numbers of the work-items, to obtain the target index space.

4. The work-group processing method according to claim 1, wherein transmitting, by the driver, the fold information of the work-groups to the compiler comprises:
transmitting, by the driver, initial numbers of work-groups in respective dimensions and initial numbers of work-items in respective dimensions in the initial index space, fold counts in respective dimensions, first fold steps corresponding to the work-groups, and second fold steps corresponding to the work-items to the compiler.

5. The work-group processing method according to claim 4, wherein unrolling, by the compiler, the folded work-groups in the target index space based on the fold information of the work-groups comprises:
unrolling the folded work-groups and folded work-items in the target index space in respective dimensions based on the fold counts in respective dimensions, the first fold steps corresponding to the work-groups and the second fold steps corresponding to the work-items;
stopping the unrolling when numbers of unrolled work-groups in respective dimensions are equal to the initial numbers of the work-groups in respective dimensions; and
updating semantic information of respective work-item functions based on the initial numbers of the work-groups in respective dimensions and the initial numbers of the work-items in respective dimensions in the initial index space, the first fold steps, and the second fold steps.

6. The work-group processing method according to claim 5, wherein unrolling the folded work-groups and folded work-items in the target index space in respective dimensions based on the fold counts in respective dimensions, the first fold steps corresponding to the work-groups and the second fold steps corresponding to the work-items comprises:
performing unrolling in respective dimensions by taking the fold counts in respective dimensions as respective unrolling loop count thresholds and taking respective current loop counts as respective loop variables in respective dimensions;
in a case that the loop variable in a current dimension is less than the corresponding unrolling loop count threshold, determining positions of unrolled work-groups in the current dimension based on the first fold steps corresponding to the work-groups, determining a number of the unrolled work-groups based on the fold count in the current dimension, and unrolling the work-groups in the current dimension based on the positions of the unrolled work-groups and the number of the unrolled work-groups; and
incrementally updating a current loop variable until the current loop variable in the current dimension is no less than the corresponding unrolling loop count threshold, acquiring a next dimension as the current dimension, and proceeding to the step of determining positions of unrolled work-groups in the current dimension based on the first fold steps corresponding to the work-groups until the folded work-groups in the target index space are unrolled in each dimension.

7. The work-group processing method according to claim 6, wherein updating the semantic information of respective work-item functions based on the initial numbers of the work-groups in respective dimensions and the initial numbers of the work-items in respective dimensions in the initial index space, the first fold steps, and the second fold steps comprises:
obtaining serial numbers of the work-groups in respective dimensions after unrolling based on serial numbers of the work-groups in respective dimensions before unrolling, the unrolling loop count thresholds in corresponding dimensions, the current loop counts in the corresponding dimensions, and the first fold steps in the corresponding dimensions;
obtaining serial numbers of global work-items in the corresponding dimensions after unrolling based on the serial numbers of the work-groups in respective dimensions after unrolling, the second fold steps in the corresponding dimensions, serial numbers of work-items within the work-groups in the corresponding dimensions before unrolling, and a global offset;
updating numbers of the work-groups in respective dimensions after unrolling based on the initial numbers of the work-groups in respective dimensions in the initial index space; and
updating numbers of the work-items in respective dimensions after unrolling based on the initial numbers of the work-items in respective dimensions in the initial index space.

8. The work-group processing method according to claim 6, wherein updating the semantic information of respective work-item functions based on the initial numbers of the work-groups in respective dimensions and the initial numbers of the work-items in respective dimensions in the initial index space, the first fold steps, and the second fold steps comprises:
obtaining serial numbers of the work-groups in respective dimensions after unrolling based on serial numbers of the work-groups in respective dimensions before unrolling, the current loop counts in corresponding dimensions, and the first fold steps in the corresponding dimensions;
obtaining serial numbers of global work-items in the corresponding dimensions after unrolling based on serial numbers of the global work-items in respective dimensions before unrolling, the second fold steps in the corresponding dimensions, the current loop counts in the corresponding dimensions, and a global offset;
updating numbers of the work-groups in respective dimensions after unrolling based on the initial numbers of the work-groups in respective dimensions in the initial index space; and
updating numbers of the work-items in respective dimensions after unrolling based on the initial numbers of the work-items in respective dimensions in the initial index space.

9. A work-group processing apparatus, comprising a memory and a processor, the memory storing a computer program thereon, wherein the processor, when executing the computer program, performs:
determining, by a driver, a number of folded work-groups;
folding an initial index space based on the number of the folded work-groups, to obtain a target index space;
transmitting work-groups described by the target index space to a device end, the work-groups described by the target index space being utilized to instruct the device end to construct waves; and
acquiring fold information of the work-groups in the target index space from the driver, transmitting the fold information of the work-groups to a compiler, and unrolling folded work-groups in the target index space based on the fold information of the work-groups by the compiler, to map the folded work-groups in the target index space to a plurality of work-groups described by the initial index space; wherein unrolled work-groups are processed in the waves constructed by the device end.

10. A non-transitory computer-readable storage medium, having a computer program stored thereon, wherein the computer program, when executed by a processor, causes the processor to perform steps of the work-group processing method according to claim 1.

11. A computer program product, comprising a computer program, wherein the computer program, when executed by a processor, causes the processor to perform steps of the work-group processing method according to claim 1.
